(19) United States
(12) Patent Application Publication
(10) Pub. No.: US 2026/0228532 A1
(43) Pub. Date: Aug. 6, 2026

(54) CACHE DATA COMPRESSION METHOD FOR TRANSFORMER-BASED NEURAL NETWORK MODEL AND ELECTRONIC DEVICE FOR PERFORMING THE SAME

(71) Applicant: SAMSUNG ELECTRONICS CO., LTD., Suwon-si (KR)

(72) Inventors: Dasol Han, Suwon-si (KR); Seungjun Shin, Suwon-si (KR); Jaehoon Oh, Suwon-si (KR); Dongwon Jang, Suwon-si (KR)

(73) Assignee: SAMSUNG ELECTRONICS CO., LTD., Suwon-si (KR)

(21) Appl. No.: 19/328,666

(22) Filed: Sep. 15, 2025

(30) Foreign Application Priority Data
Feb. 6, 2025 (KR) 10-2025-0014998
Apr. 11, 2025 (KR) 10-2025-0047503

(51) Int. Cl. G06N 3/082; G06N 3/0495

(52) U.S. Cl. CPC G06N 3/082; G06N 3/0495

(57) ABSTRACT

A cache data compression method for a transformer-based neural network model and an electronic device for performing the same are provided. The cache data compression method includes obtaining a query tensor, a key tensor, and a value tensor corresponding to tokens, determining token importance for each of the tokens based on the query tensor and the key tensor, clustering the key tensor and the value tensor into a plurality of clusters based on the determined token importance, determining channel importance of channels included in at least one of the key tensor and the value tensor in each of the plurality of clusters, generating compressed key-value data by pruning at least one of the channels of the key tensor and the value tensor based on the determined channel importance, and storing the compressed key-value data as key-value cache data for the transformer-based neural network model.

### CROSS-REFERENCE TO RELATED APPLICATION

This application claims priority from Korean Patent Application No. 10-2025-0014998, filed on Feb. 6, 2025, and Korean Patent Application No. 10-2025-0047503, filed on Apr. 11, 2025, in the Korean Intellectual Property Office, the disclosures of which are incorporated herein by reference in their entireties.

### BACKGROUND

### 1. Field

Methods and apparatuses consistent with embodiments relate to a cache data compression method for a transformer-based neural network model and an electronic device for performing the same.

### 2. Description of the Related Art

A large language model (LLM) is a deep learning-based model that is trained with very large-scale data. The LLM specializes in understanding and generating text data. The LLM has revolutionized the field of natural language processing, and is one of the key technologies that enables computers to understand and process human language. Representative LLMs include generative pre-trained transformers (GPT) and bidirectional encoder representations from transformers (BERT). LLMs generally include hundreds of millions to hundreds of billions of parameters, and the size of the LLMs is gradually increasing for higher inference accuracy.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of an embodiment, there is provided a cache data compression method for a transformer-based neural network model, the cache data compression method including obtaining a query tensor, a key tensor, and a value tensor corresponding to tokens, determining token importance for each of the tokens using the query tensor and the key tensor, clustering the key tensor and the value tensor into a plurality of clusters based on the determined token importance, determining channel importance of channels included in at least one of the key tensor and the value tensor in each of the plurality of clusters, generating compressed key-value data by pruning at least one of the channels of the key tensor and the value tensor based on the determined channel importance, and storing the compressed key-value data as key-value cache data for the transformer-based neural network model.

The clustering may include clustering the key tensor and the value tensor into a predetermined number of clusters.

The plurality of clusters may have dimension sizes different from each other.

The clustering may include determining respective dimension sizes of the plurality of clusters, and clustering the key tensor and the value tensor into the plurality of clusters having the determined dimension sizes.

The generating of the compressed key-value data may include pruning at least one channel among the channels of the key tensor and the value tensor based on a dimension size assigned to each of the clusters and the determined channel importance.

The generating of the compressed key-value data may include retaining a portion of a channel dimension of at least one of the channels included in the key tensor and the value tensor, and zero-padding the remaining portion.

The determining of the token importance may include generating an attention map for each of the tokens based on the query tensor and the key tensor for each of the tokens, and determining the token importance based on the attention map.

The plurality of clusters may include a first cluster and a second cluster, and based on a first token importance corresponding to the first cluster, being greater than a second token importance corresponding to the second cluster, a higher dimension size may be assigned to the first cluster than to the second cluster.

The determining of the channel importance may include determining the channel importance of each key channel and each value channel of the plurality of clusters.

The generating of the compressed key-value data may include pruning at least one channel among the channels of the key tensor and the value tensor included in at least one cluster based on a dimension size assigned to each of the plurality of clusters and the determined channel importance.

The cache data compression method may include determining a calibration value based on a result value of the pruning of the at least one of the channels of the key tensor and the value tensor based on the determined channel importance, and storing the determined calibration value.

The calibration value may be a value for calibrating a dot product result value of the query tensor and the key tensor used to calculate an attention score in the transformer-based neural network model, and is applied to an input of at least one of a head and a layer of the transformer-based neural network model.

According to another aspect of an embodiment, there is provided a non-transitory computer-readable storage medium storing instructions that, when executed by a processor of an electronic device, cause the electronic device to perform obtaining a query tensor, a key tensor, and a value tensor corresponding to tokens; determining token importance for each of the tokens based on the query tensor and the key tensor; clustering the key tensor and the value tensor into a plurality of clusters based on the determined token importance; determining channel importance of channels included in at least one of the key tensor and the value tensor in each of the plurality of clusters; generating compressed key-value data by pruning at least one of the channels of the key tensor and the value tensor based on the determined channel importance; and storing the compressed key-value data as key-value cache data for a transformer-based neural network m.

According to another aspect of an embodiment, there is provided an electronic device for performing a cache data compression method for a transformer-based neural network model, the electronic device including a memory storing instructions, and a processor configured to execute the instructions.

When the instructions are executed by the processor, the electronic device is configured to obtain a query tensor, a key tensor, and a value tensor corresponding to tokens, determine token importance for each of the tokens based on the query tensor and the key tensor, cluster the key tensor and the value tensor for the tokens into a plurality of clusters based on the determined token importance, determine channel importance of channels included in at least one of the key tensor and the value tensor in each of the plurality of clusters, generate compressed key-value data by pruning at least one of the channels of the key tensor and the value tensor based on the determined channel importance, and store the compressed key-value data in the memory as key-value cache data for the transformer-based neural network model.

When the instructions are executed by the processor, the electronic device may be configured to cluster the key tensor and the value tensor into a predetermined number of clusters.

When the instructions are executed by the processor, the electronic device may be configured to determine respective dimension sizes of the plurality of clusters, and cluster the key tensor and the value tensor into the plurality of clusters having the determined dimension sizes.

When the instructions are executed by the processor, the electronic device may be configured to, when performing the pruning, retain a portion of a channel dimension of at least one of the channels included in the key tensor and the value tensor, and zero-padding the remaining portion according to the determined channel importance.

When the instructions are executed by the processor, the electronic device may be configured to generate an attention map for each of the tokens based on the query tensor and the key tensor for each of the tokens, and determine the token importance based on the attention map.

When the instructions are executed by the processor, the electronic device may be configured to prune at least one channel among the channels of the key tensor and the value tensor included in at least one cluster based on a dimension size assigned to each of the plurality of clusters and the determined channel importance.

When the instructions are executed by the processor, the electronic device may be configured to determine a calibration value based on a result value of the pruning of the at least one of the channels of the key tensor and the value tensor based on the determined channel importance, and store the calibration value in the memory.

The calibration value may be a value for calibrating a dot product result value of the query tensor and the key tensor used to calculate an attention score in the transformer-based neural network model, and is applied to an input of at least one of a head and a layer of the transformer-based neural network model.

Additional aspects of embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain example embodiments with reference to the accompanying drawings, in which:

FIG. 1 is a block diagram illustrating a configuration of an electronic device according to an embodiment;

FIG. 2 is a diagram illustrating an architecture of a transformer-based neural network model according to an embodiment;

FIG. 3 is a flowchart illustrating operations of a cache data compression method for a transformer-based large language model (LLM) according to an embodiment;

FIGS. 4A and 4B are diagrams illustrating clustering into clusters with different dimensional sizes according to token importance according to an embodiment; and

FIGS. 5 and 6 are flowcharts illustrating cache data compression methods for a transformer-based neural network model according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used in connection with the present disclosure, the term “module” may include a unit implemented in hardware, software, or firmware, and may interchangeably be used with other terms, for example, “logic,” “logic block,” “part,” or “circuitry”. A module may be a code block that performs a predetermined function or task, and may configure a larger program or a software system through interaction with other modules. Alternatively, a module may refer to a hardware component or device capable of performing a function independently, and such a module may be combined with other hardware to form a whole system. A module may be a single integral component, or a minimum unit or part thereof, adapted to perform one or more functions. For example, according to an embodiment, the module may be implemented in the form of an application-specific integrated circuit (ASIC).

In the present disclosure, the term “an embodiment” is intended to encompass one or more embodiments, rather than being limited to a single example. Furthermore, features described in embodiments may be combined and implemented together.

At least one of the operations described in the embodiments of the present disclosure may be performed simultaneously or in parallel with other operations, and the order of the operations may be changed. In addition, at least one of the operations may be omitted, or another operation may be additionally performed.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

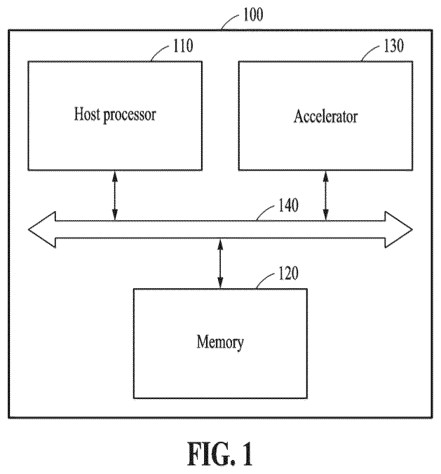

FIG. 1 is a block diagram illustrating a configuration of an electronic device according to an embodiment.

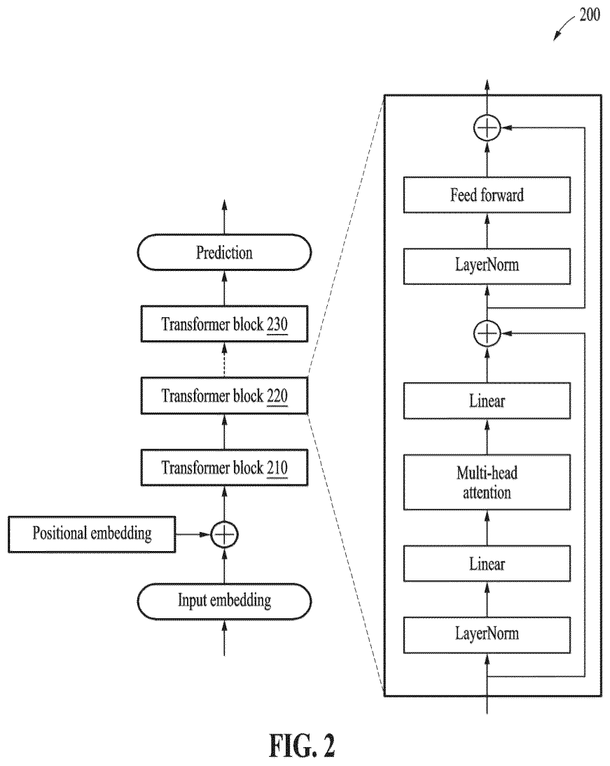

Referring to FIG. 1, an electronic device 100 may perform tasks using a transformer-based neural network model. The electronic device 100 may be included in and operate in connection with various devices (e.g., a mobile device such as a smartphone, a camera, and a tablet, a home appliance (e.g., a smart television (TV)), an automobile, an augmented reality (AR)/virtual reality (VR) device, a medical imaging device, a server, a personal computers (PC), a data center, or an accelerator device) using a transformer-based neural network model. The electronic device 100 may be used in various fields where a transformer-based neural network model operates. In embodiments to be described below, for convenience of description, a transformer-based neural network model is described as an example of a large language model (LLM) (e.g., an LLM 200 of FIG. 2). However, it should not be construed that the scope of embodiments is limited thereto, and it is obvious to those skilled in the art that the embodiments of the present disclosure and operations performed by the electronic device 100 may be applied not only to applications in which a transformer-based neural network model is used as an LLM, but also to other applications.

The electronic device 100 may include a host processor 110 and a memory 120. According to an embodiment, the electronic device 100 may further include an accelerator 130. Various components included in the host processor 110 and the accelerator 130 are software packages, code, and/or instruction sets or instructions, and may be modules that may be implemented as hardwired circuitry, programmable circuitry, state machine circuitry, and/or firmware that stores instructions executed by the programmable circuitry.

The host processor 110, the memory 120, and the accelerator 130 may communicate with each other through a communication network (or a communication interface) 140. The communication network may include, for example, a communication bus, a Network on a Chip (NoC), or Peripheral Component Interconnect Express (PCIe). According to an embodiment, the electronic device 100 may not include some components (e.g., the accelerator 130) and may further include other components (e.g., a communication circuit for communicating with another device, an input device for obtaining a user input, or an output device for outputting a processing result). The host processor 110 may execute a program or software to control other components (e.g., a hardware or software component) of the electronic device 100 connected to the host processor 110 and may perform a variety of data processing or operations. As at least part of data processing or operations, the host processor 110 may process instructions or data stored in the memory 120 and store result data after processing in the memory 120. The host processor 110 may perform an operation of the electronic device 100 described herein or an algorithm corresponding to the operation. The host processor 110 may be a hardware-implemented data processing device having circuitry that is physically structured to execute desired operations. For example, the desired operations may be implemented by code or instructions included in a program. The host processor 110 may also be referred to as a “processor.”

The host processor 110 may include a main processor (e.g., a central processing unit (CPU) or an application processor (AP)). The host processor 110 may further include at least one of auxiliary processors (e.g., a graphics processing unit (GPU), a neural processing unit (NPU), an image signal processor (ISP), a sensor hub processor, or a communication processor (CP)) that is operable independently from, or in conjunction with the main processor. The auxiliary processor may be implemented separately from the main processor or as a part of the main processor. The host processor 110 may also be implemented as a system on chip (SoC) or an integrated circuit (IC) that performs processing. The host processor 110 may include a processing circuit or may include a plurality of host processors. For example, the host processor 110 may include various processing circuits including one or more host processors, in which the one or more host processors may be configured to perform various functions described herein in a distributed manner individually and/or collectively. When the “host processor (or processor)” is described herein as performing a plurality of operations (or functions), this includes, but is not limited to, situations where a single host processor performs all of the operations or situations where one host processor performs some of the plurality of operations and another host processor performs the other operations.

The memory 120 may store data used by at least one component (e.g., the host processor 110) of the electronic device 100. The data may include, for example, software, input data or output data for instructions related thereto, data (e.g., code or parameter values) related to an LLM, and key-value cache data. The memory 120 may store instructions executable by the host processor 110. The memory 120 may include one or more memories, and instructions for controlling the host processor 110 to perform operations of the electronic device 100 described herein may be stored in one memory or may be divided and stored in a plurality of memories. The memory 120 may include a volatile memory or a non-volatile memory. The memory 120 may include a main memory such as, for example, a dynamic random access memory (DRAM) and a cache memory. The instructions, when executed by the host processor 110, may cause the electronic device 100 to perform various operations of the electronic device 100 described herein.

The accelerator 130 may process tasks that may be more efficiently processed by a separate processor, rather than by the host processor 110 due to characteristics of the operation. For example, operations on an LLM may be executed on the accelerator 130. When the accelerator 130 receives a command from the host processor 110, data may be input to the LLM. The accelerator 130 may include, for example, an NPU, a tensor processing unit (TPU), a digital signal processor (DSP), a GPU, and/or a neural engine. In some embodiments, tasks handled by the accelerator 130 may also be processed by the host processor 110.

An LLM is a deep learning-based model trained with very large-scale data and may be a type of neural network. The LLM may include a transformer (or a transformer model or a transformer block) that includes an attention block and a feedforward block. The attention block and the feedforward block may each output a feature map. The attention block may perform an operation based on a self-attention mechanism. For example, the attention block may transform input data into a query Q, a key K, and a value V, and compute importance by a dot product of the query and the key.

To achieve high performance, the LLM may contain a large number of parameters. As a result, the size of the LLM increases, which places increased demands on the hardware resources of the electronic device 100 that executes the LLM. For example, a huge amount of memory resources may be required to support LLM operations such as inference. If the memory capacity is insufficient, the processing speed using the LLM may slow down, and system-level issues may arise due to excessive memory consumption. To solve or prevent such problems, it may be important to efficiently utilize the data processed or loaded by the LLM.

In the processing using the LLM, a large amount of computation is required in the self-attention block, and as the length of a sequence to be processed by the LLM increases, the amount of computation may rapidly increase and the response latency may increase. To solve such problems, transformer-based LLMs may be implement a key-value caching mechanism, in which the key-value pairs generated during an initial processing step are stored in the memory 120 as key-vale cache data and are used in a next processing process to reduce redundant computations. The LLM may refer to past key-value cache data to understand context. For example, when predicting a first token, all of the query, the key, and the value may be computed and the computed key and value may be stored (stored as key-value cache data). When predicting a subsequent token, only the query is newly computed and the previously stored key and value may be reused. This method of using the key-value cache data may significantly speed up computation by reducing the need to recompute keys and values during the inference process. The query, the key, and the value described here may each be expressed as a tensor. A tensor may represent a data type with a data structure that may be 0-dimensional (e.g., a single number or a scalar), 1-dimensional (e.g., a vector), or multi-dimensional (e.g., a matrix of two or more dimensions or a three-dimensional (3D) array).

To improve the performance of LLM, the length of a sequence and/or the size of a context window processed by the transformer are gradually increasing. As the length of the sequence and/or the size of the context window increases, the size of the key-value cache data may increase greatly, which may significantly increase the overhead of the memory 120 and the latency. This may limit the expandability and cost-effectiveness of the LLM, particularly in real-time inference scenarios using the LLM and in environments where hardware resources are limited. According to embodiments of the present disclosure, the problems described above may be solved by efficiently compressing, storing, and using key-value cache data generated during input prompt processing of the LLM. The electronic device 100 may reduce the usage of the memory 120 while maintaining the performance of the LLM by effectively compressing key-value cache data generated in a self-attention operation within the transformer block of the LLM. According to an embodiment, the electronic device 100 may perform variable-dimension pruning on the key-value cache data for the channels of each token to compress the key-value cache data. The electronic device 100 may compute the importance of each token and perform pruning in variable dimensions according to the importance of each token. Pruning may refer to the process of removing operations (computations) or data deemed to be unnecessary, redundant, or of low importance in order to improve efficiency and/or performance in the LLM. By compressing the key-value cache data, the size of the key-value cache data stored in the memory 120 (or cache memory) may be reduced, thereby reducing the usage of the memory 120 and improving a decoding processing speed in the LLM. The electronic device 100 may overcome the limitation of binary pruning, which stores tokens with high importance and removes tokens with low importance, of not reflecting context or detailed information provided by tokens with medium importance, by finely adjusting the level of pruning according to the importance of each token. The electronic device 100 may effectively maintain the performance of the LLM and the quality of inference results by performing processing on the tokens with medium importance and minimizing information loss due to pruning.

FIG. 2 is a diagram illustrating an architecture of a transformer-based neural network model according to an embodiment.

Referring to FIG. 2, as an example of the transformer-based neural network, a transformer may be used as a neural network structure for implementing the LLM 200. In the LLM 200, input embedding is a scheme understandable by the LLM 200 and may represent a process of transforming a token (e.g., a word) into a tensor form. An input prompt may be transformed into a plurality of tokens through tokenization, and the tokens may be transformed into a tensor form (e.g., a high-dimensional vector) through the input embedding. In order for the transformer for implementing the LLM 200 to handle sequential information, positional information of tokens (e.g., relative order information between tokens) may be required. In the LLM 200, positional embedding may refer to a process of adding positional information corresponding to a token (or a word) to input data of the transformer. The positional embedding may be performed by combining token embeddings (which represent the content or meaning of the tokens) with positional embeddings (which represent the position of each token in the sequence). The positional embedding may be classified into at least two types, absolute positional embedding and relative positional embedding. The absolute positional embedding may be a scheme of adding an absolute position of a token, as the positional information, to input data. A unique embedding vector may be assigned to each absolute position in the input sequence (e.g., first token, second token, etc.). These vectors are added to the corresponding token embeddings so that the transformer can distinguish between tokens based on their fixed position in the sequence. The relative positional embedding may be a scheme of adding a relative distance from each token to a surrounding token, as the positional information, to input data. The relative positional embedding method encodes the relative distances between tokens, to provide information about how far apart two tokens are from each other, so that the LLM 200 focuses on the relationships between tokens (regardless of or in addition to their absolute positions). The input embedding and the positional embedding may be performed to generate an embedding vector, and the generated embedding vector may be input to an input layer of the transformer as the input data.

The LLM 200 may include a plurality of transformer blocks 210, 220, and 230. The transformer block 210 may receive a token on which the input embedding and the positional embedding are performed. The plurality of transformer blocks 210, 220, and 230 may be connected in series. For example, the upper transformer block 220 may receive an output of the lower transformer block 210. Each of the transformer blocks 210, 220, and 230 may include a plurality of sub-layers (or blocks). For example, the transformer block 220 may include a normalization layer (e.g., LayerNorm), a linear layer (e.g., Linear), a multi-head attention layer (e.g., Multi-head Attention), and a feedforward layer (e.g., Feed Forward). The connection relationship, the number, and detailed structure of the transformer blocks 210, 220, and 230 described above are only examples and are not limited thereto. The transformer block may include more layers or different types of layers in addition to the layers illustrated in FIG. 2. The LLM 200 illustrated in FIG. 2 is based on a model with a decoder structure, but the LLM 200 may also be based on a model with a structure including an encoder and a decoder or an encoder structure.

The normalization layer may normalize an output of a previous layer and transmit the output to a next layer. The linear layer may perform linear transformation on the input and/or output to the multi-head attention layer. The linear layer may be used to reconstruct the output of the multi-head attention layer and to match dimensions. The multi-head attention layer may identify relationships between input tokens using the self-attention mechanism. The self-attention mechanism may be a process of calculating an attention (or score) value that indicates how related each token is to other tokens. Each of head attention layers included in the multi-head attention layer may normalize weights using softmax and multiply the value V by the weights to generate output data. In the head attention layers, such self-attention mechanism may be performed in parallel. Each head attention layer may interpret the input differently using independent query, key, and value.

Each of the tokens input in the multi-head attention layer may be transformed into a query, key, and value. The query, key, and value may each be of a tensor type. A query may be information for evaluating relationships between a current token and other tokens. For example, the query may determine which token the current token is required to focus on. A key may be a vector in which each token represents its own information. For example, the key may be a vector used to compute a similarity indicating how related the current token is to other tokens by comparing the query of the current token with queries of the other tokens. A value may be a vector representing contextual information of each token. The value may be used to generate a final attention value by being applied with the attention weight. The feedforward layer may perform additional nonlinear transformation after the self-attention mechanism terminates. The feedforward layer may transform the input of the feedforward layer using a fully-connected layer and add nonlinearity using an activation function (e.g., a rectified linear unit (ReLU)).

In the LLM 200, an output block (e.g., Prediction) may generate an inference result or a prediction result based on the output of the last transformer block (e.g., the transformer block 230).

As described above, in order to improve the performance of the LLM 200, the length of the sequence and/or the size of the context window processed by the transformer are gradually increasing, and accordingly, the size of the generated key-value cache data is also increasing. As the size of key-value cache data increases, the memory usage may increase rapidly, and thus, the size of key-value cache data is a bottleneck that determines the performance of the LLM 200. According to various embodiments of the present specification, the memory usage may be effectively reduced without performance degradation of the LLM 200 by performing the variable dimension pruning for channels of each token on the key-value cache data. Hereinafter, operations of performing the variable dimension pruning to generate compressed key-value cache data will be described in detail.

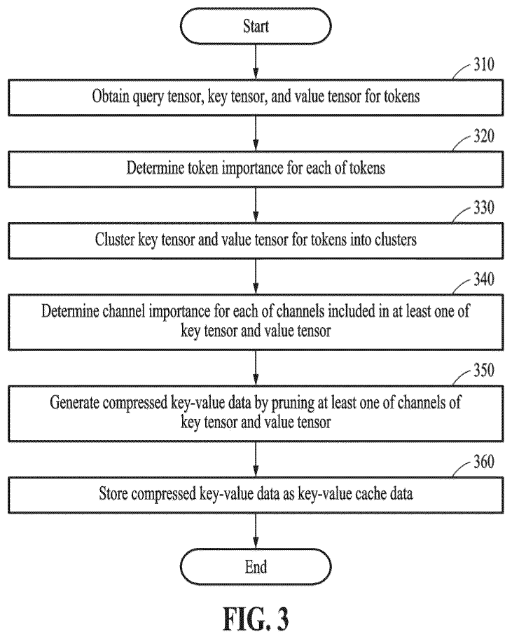

FIG. 3 is a flowchart illustrating operations of a cache data compression method for a transformer-based LLM according to an embodiment. The operations of the cache data compression method may be performed by an electronic device described herein (e.g., the electronic device 100, the host processor 110, or the accelerator 130 of FIG. 1). Referring to FIG. 3, in operation 310, the electronic device may obtain a query tensor, a key tensor, and a value tensor for tokens. An input prompt is an input text given to an LLM (e.g., the LLM 200 of FIG. 2), and may be, for example, an input including a sentence, a command, or a context. The electronic device may transform the input prompt into tokens, transform each token into an embedding vector, and then apply a defined weight matrix to the embedding vector (e.g., matrix multiplication) to generate the query tensor, the key tensor, and the value tensor. The weight matrix may be trained during a training process of the LLM, and there may be a weight matrix for calculating the query tensor, a weight matrix for calculating the key tensor, and a weight matrix for calculating the value tensor, respectively.

In operation 320, the electronic device may determine a token importance for each of the tokens using the query tensor and the key tensor for the tokens. According to an embodiment, the electronic device may further utilize the value tensor for tokens to determine the token importance. The token importance may be a score that indicates how important each token is relative to other tokens. Even if the tokens have the same text, the tokens may have different token importance depending on the key tensor and/or value tensor of each token. The token importance may be determined, for example, by a metric based on the attention map, a metric based on the magnitude of the key tensor and/or the value tensor, or a metric based on the similarity.

For the metric based on the attention map, the electronic device may generate an attention map for each of the tokens based on the query tensor and the key tensor for each of the tokens, and determine the token importance based on the generated attention map. A process of normalizing the attention map may be optionally performed before determining the token importance, and when the normalization process is performed, the token importance may be determined based on the normalized attention map. The electronic device may generate the attention map through the dot product of the query tensor and the key tensor. The result of the dot product may be divided by the square root of the dimension of the key tensor to adjust the scale of the attention map, and the attention map divided by the square root of the dimension of the key tensor may indicate how much the query focuses on each key. When the normalization process is performed on the attention map, the attention map divided by the square root of the dimension of the key tensor may be normalized through the softmax function. By the softmax function, a value of the attention map may be transformed into a value between 0 and 1, and the transformed value may probabilistically represent how much the query focuses on each key. The electronic device may determine the token importance of each token based on the value of the attention map normalized by the softmax function. The importance of the key may be computed by summing values (e.g., attention values) along a query axis of the normalized attention map. The importance of the key computed in this way represents the relative importance of each key, and the computed importance of the key may be used as the importance of each token.

For the metric based on the size of the key tensor and/or value tensor, the electronic device may compute an L1 norm value (sum of absolute values) or L2 norm value (Euclidean length) of the key tensor and/or value tensor, which represents the size of a vector for the key tensor or the value tensor, and determine the token importance as a greater value as the L1 norm or the L2 norm value is great.

For the metric based on the similarity, the electronic device may compute a cosine similarity between an original value and a result value obtained by pruning the key tensor and/or the value tensor of the tokens by a predetermined percentage (e.g., 50%). The electronic device may determine that the token importance is high when the cosine similarity is low, and may determine that the token importance is low when the cosine similarity is high. This method may evaluate how critical a token is to maintaining information, by measuring the cosine similarity between the original version without pruning and the pruned version. If pruning significantly changes the tensor (low similarity), the token is deemed important.

In operation 330, the electronic device may cluster the key tensor and the value tensor for tokens into a plurality of clusters based on the token importance. The electronic device may cluster the key tensor and the value tensor into the predetermined number of clusters, where the clusters may have different dimension sizes. For the clustering, metrics such as K-means clustering, K-nearest neighbors clustering, threshold-based clustering, a greedy algorithm, or linear programming may be used. According to an embodiment, the number of clusters may be 1 or may be as many as the number of tokens.

The electronic device may determine the dimension size of each of the plurality of clusters. The plurality of clusters may include a first cluster and a second cluster, and when token importance corresponding to the first cluster is greater than token importance corresponding to the second cluster, a greater dimension size may be assigned to the first cluster than to the second cluster. In an embodiment, the token importance and the dimension size assigned to a cluster may be modeled to have a positive correlation, and the dimension sizes of the plurality of clusters may be assigned to satisfy specific conditions. The specific conditions may include, for example, that the sum of the dimension sizes assigned to each cluster should not exceed a total dimension size available, that a greater dimension size should be assigned as the importance of the cluster is high, and that the dimension size to be assigned to each cluster should fall within a range of predetermined minimum and maximum values. However, these conditions are only examples and are not limited thereto. Some of the conditions may not apply, or other conditions may apply additionally. The electronic device may cluster the key tensor and the value tensor into clusters with the determined dimension sizes. Rather than assigning the same dimension size to all clusters, the electronic device may adaptively assign a length and dimension of the key tensor and the value tensor based on a functional role of each cluster. Here, the cluster may correspond to a head block of the transformer.

In operation 340, the electronic device may determine channel importance for each of channels included in at least one of the key tensor and the value tensor in each of the plurality of clusters. The channel importance may be a score that quantifies how important each channel of the key tensor and the value tensor is in the attention mechanism. In the key tensor or the value tensor, a channel may represent a dimension of the key tensor or the value tensor in the embedding space (e.g., an embedding size of the key tensor or the value tensor). For example, when the key tensor has a dimensionality of 128 (or includes 128 vectors), the key tensor may be treated as having 128 channels. Each channel may correspond to a scalar feature shared across all token vectors (e.g., Q, K, V vectors) while the embodiments of the present disclosure are not limited thereto. The electronic device may determine the channel importance of each key channel and each value channel of the plurality of clusters. The electronic device may compute the channel importance of the channel of the key tensor and/or the channel of the value tensor of each cluster for effective pruning.

When there are five (5) tokens and three (3) channels per tensor per token, the tokens and channels may be represented as columns and rows, respectively, as shown below:

| | Token 1 | Token 2 | Token 3 | Token 4 | Token 5 |
|---|---|---|---|---|---|
| Query Ch 1 | V1-1 | V2-1 | V3-1 | V4-1 | V5-1 |
| Query Ch 2 | V1-2 | V2-2 | V3-2 | V4-2 | V5-2 |
| Query Ch 3 | V1-3 | V2-3 | V3-3 | V4-3 | V5-3 |
| Key Ch 1 | V1-4 | V2-4 | V3-4 | V4-4 | V5-4 |
| Key Ch 2 | V1-5 | V2-5 | V3-5 | V4-5 | V5-5 |
| Key Ch 3 | V1-6 | V2-6 | V3-6 | V4-6 | V5-6 |

In the above, each channel may include tensor data (e.g., float vectors such as V1-1, V2-1, V3-1, V4-1, and V5-1 for Query Channel 1).

In an embodiment, the electronic device may determine, as the channel importance, a value obtained by measuring a magnitude of an interaction between the query tensor and the key tensor for each channel in the cluster. For example, the size of the matrix multiplication between the query tensor and the key tensor may be determined as the channel importance. The matrix multiplication described herein may include multiplying one of two target matrices by transposing it. Other metrics for determining the channel importance may include a size-based metric or a singular value-based metric. In the size-based metric, the size of each channel of the tensor may be calculated using, for example, the L1 norm or L2 norm, and the channel importance may be determined based on the size of the channel. As the size of the channel is large, the channel importance may be determined to be high. In the singular value-based metric, for example, singular value decomposition may be used to obtain a singular value for each channel of the tensor, and the channel importance may be determined based on the size of the singular value. As the singular value is large, the channel importance may be determined to be high.

In operation 350, the electronic device may generate compressed key-value data by pruning at least one of the channels of the key tensor and the value tensor based on the determined channel importance. The operation of generating the compressed key-value data may include an operation of pruning some of the channels included in the key tensor and value tensor according to the determined channel importance. When a channel of the key tensor is pruned, a corresponding channel of the value tensor may also be pruned. Alternatively, when a channel of the value tensor is pruned, a corresponding channel of the key tensor may also be pruned. In an embodiment, when pruning the channel, the electronic device may retain a portion of a channel dimension of at least one of the channels included in the key tensor and the value tensor, and zero-pad the remaining portion. The electronic device may replace a value of a channel to be removed according to a pruning ratio, with 0. In an embodiment, after the channel is pruned, the dimension size may be stored in a reduced state, and when it is used later, zero padding may be performed for an insufficient dimension size to restore to an original dimension size.

The electronic device may prune a channel with lower importance based on the channel importance and the dimension size assigned to each cluster. The electronic device may prune at least one channel among the channels of the key tensor and the value tensor included in at least one cluster based on the dimension size assigned to each of the clusters and the determined channel importance. For example, the electronic device may obtain a selection matrix that minimizes a difference between (a value of matrix multiplication of the query tensor and the key tensor) and (a value of matrix multiplication of the query tensor, the selection matrix, and the key tensor) based on a given pruning ratio (e.g., 30% or 50%). The selection matrix may be a diagonal matrix including binary values, for example, 1 indicating channel retention and 0 indicating channel pruning. The selection matrix may be optimized by a greedy algorithm. The electronic device may determine to retain the channel of the key tensor that is multiplied by the value of 1 of the selection matrix, and prune the channel of the key tensor that is multiplied by the value of 0 of the selection matrix. As the magnitude of the interaction between the query tensor and the key tensor is large, the channel importance may be determined as a large value. The electronic device may determine to retain the channel with high channel importance and prune the channel with low channel importance, in order to retain channels that contribute significantly to the attention mechanism. Such variable channel pruning may keep the flow of key information to minimize the loss of important information.

In an embodiment, the electronic device may prune at least one of the channels of the key tensor and the value tensor based on the channel importance determined in operation 340, and determine a calibration value (or bias term) based on a result value of the pruning. The calibration value may be a value for calibrating a result value of the dot product of the query tensor and the key tensor used to calculate an attention score in the transformer. The calibration value is a value for calibrating a difference between a dot product value of the query tensor and the key tensor and a dot product value of the pruned query tensor and key tensor. The calibration is also possible for the value tensor, and the calibration value may have different values for the layer, head, key tensor, and/or value tensor of the transformer. The calibration value may be stored in a memory and applied to an input of at least one of the head and the layer of the transformer in the inference process of a next token. For example, the calibration value may be added to the input values of the head and the layer of the transformer and may be input. The loss due to the pruning may be reduced by applying the calibration value.

In operation 360, the electronic device may store the compressed key-value data as key-value cache data for a transformer-based LLM. The key-value cache data may include intermediate representation information for sequential tokens received as input by the transformer. The key-value cache data may include data for a key tensor and data for a value tensor corresponding to the key tensor. The key tensor and the value tensor stored in the key-value cache data may form a pair. As described above, through the process of performing the pruning on channels according to the dimension size assigned to the cluster and the channel importance of each channel, the key-value cache data may be optimized and the optimized key-value cache data may be stored in a memory (e.g., a cache memory). The stored key-value cache data may be used in the inference process for a next token. As described above, the electronic device may variably prune the channels of the key tensor and value tensor according to the channel importance. For example, the electronic device may perform variable pruning, such as fully preserving, preserving some dimensions, or removing channels of each cluster, based on the dimension size assigned to each cluster. More memory resources may be secured through the variable pruning, which retains sufficient dimension for important clusters and performs high-level pruning for less important clusters. According to the variable pruning, the dimension size of each token in key cache data may be different. Since the dimension size of each token in the key cache data is different, the attention calculation may be divided by the number of variable dimension types and performed in the self-attention mechanism. The electronic device may reduce the memory usage and improve the processing speed of the LLM by finely adjusting the level of pruning based on the token importance for the tokens and the channel importance. In addition, the loss of information contained in tokens with intermediate importance may be minimized so that the inference performance of the LLM may be effectively maintained. This makes it possible to implement the LLM on-device that was previously impossible to implement on-device due to limited hardware resources, and improve user experience by providing high-performance artificial intelligence-based services to users in real time. In addition, the proposed cache data compression method may reduce the memory usage and improve the decoding processing speed of the transformer, thereby enabling efficient inference and reduction of operating costs of the LLM in a cloud infrastructure environment, and contributing to shortening the response time when providing services.

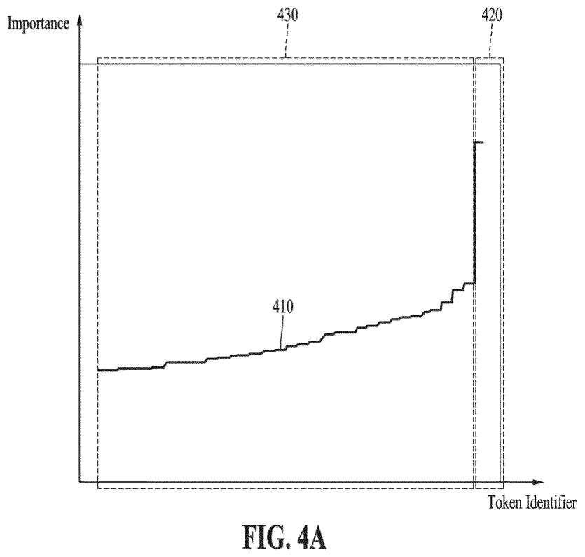

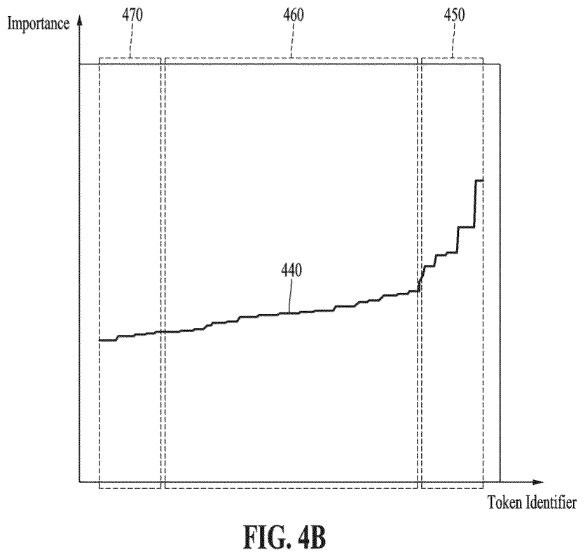

FIGS. 4A and 4B are diagrams illustrating clustering into clusters with different dimensional sizes depending on token importance according to an embodiment.

An electronic device (e.g., the electronic device 100 of FIG. 1) may assign different dimension sizes to clusters to perform variable pruning depending on the token importance. The dimension size assigned to each cluster may vary depending on given conditions. Referring to FIG. 4A, importance for each token (the token importance) 410 is shown. The horizontal axis represents a token identifier of each token, and the vertical axis represents a magnitude of the importance of each token. As shown in FIG. 4A, the electronic device may cluster key tensors and value tensors of tokens 420 with high importance (e.g., importance greater than or equal to a threshold value) into a first cluster, and cluster key tensors and value tensors of tokens 430 with relatively low importance (e.g., importance less than the threshold value) into a second cluster. The electronic device may assign a greater dimension size to a cluster including key tensors and value tensors of tokens with greater importance. The electronic device may, for example, determine to retain 100% of the dimension size of the key tensor and the value tensor of the token for the first cluster, and to retain only a portion (e.g., 50%) of the dimension size of the key tensor and the value tensor of the token for the second cluster. The number of clusters determined by performing the clustering may be set in advance, and the dimension size assigned to each cluster may be determined to satisfy specific conditions. For example, the dimension size to be assigned to each cluster may be determined under the conditions that the sum of the dimension sizes assigned to the clusters is within a range of predetermined minimum and maximum values without exceeding the total available dimension size.

If it is assumed that the importance of each token (token importance) 440 is determined as shown in FIG. 4B, the electronic device may cluster the key tensor and value tensor of tokens 450 having high importance (e.g., importance equal to or greater than a first threshold value) into a first cluster, cluster the key tensor and value tensor of tokens 460 having medium importance (e.g., importance equal to or greater than a second threshold value and less than the first threshold value) into a second cluster, and cluster the key tensor and value tensor of tokens 470 having low importance (e.g., importance less than the second threshold value) into a third cluster. The electronic device may determine to retain 100% of the dimension size of the key tensor and the value tensor of the tokens for the first cluster, to retain only a portion (e.g., 50%) of the dimension size of the key tensor and the value tensor of the tokens for the second cluster, and to remove (e.g., to retain 0% of) the key tensor and the value tensor of the tokens for the third cluster.

Removing the key tensor and the value tensor of relatively less important tokens when generating the key-value cache data in order to reduce the memory usage may degrade the performance of the LLM because the contextual information contained in the tokens may be completely lost. According to the method proposed in this specification as described above, by retaining a portion of the dimensions of the key tensor and the value tensor of the tokens 460 with medium importance, the memory usage may be reduced while the contextual information of the tokens 460 may be reflected in the inference result, thereby minimizing the performance degradation of the LLM due to pruning.

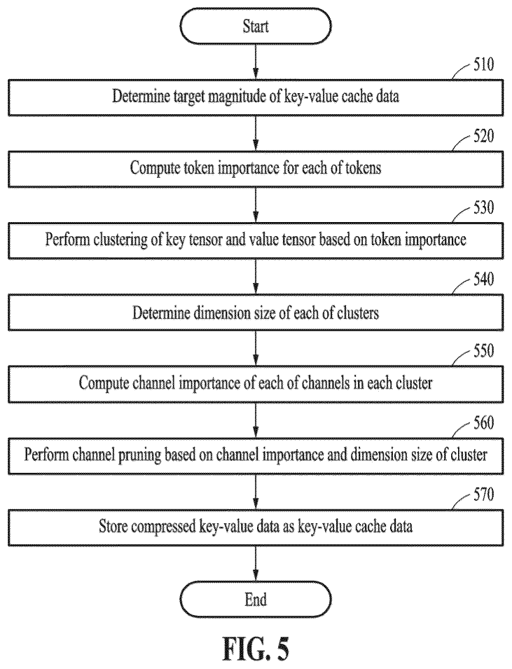

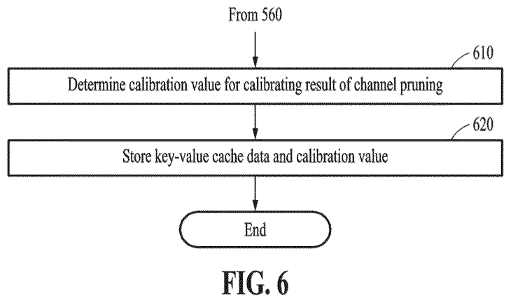

FIGS. 5 and 6 are flowcharts illustrating cache data compression methods for a transformer-based neural network model according to an embodiment. The operations of the cache data compression method may be performed by an electronic device described herein (e.g., the electronic device 100, the host processor 110, or the accelerator 130 of FIG. 1). Referring to FIG. 5, in operation 510, the electronic device may determine a target magnitude of key-value cache data to be applied to a transformer-based neural network model (e.g., the LLM 200 of FIG. 2). The electronic device may determine the target magnitude of the key-value cache data by considering conditions such as the capacity of a storage device (e.g., a memory) and/or required processing performance. For example, as the capacity of the memory is large or the required processing performance is high, the target magnitude of the key-value cache data may be determined to be large.

In operation 520, the electronic device may compute token importance for each of the tokens. The electronic device may obtain a query tensor, a key tensor, and a value tensor for the tokens, and may compute token importance for each of the tokens using the query tensor and the key tensor for the tokens. As described above, the electronic device may compute the token importance, for example, through a metric based on an attention map, a metric based on the size of the key tensor and/or value tensor, or a metric based on a similarity. The electronic device may also use a variety of other metrics to compute the token importance.

In operation 530, the electronic device may perform clustering of the key tensor and the value tensor for tokens based on the token importance. This process may result in one or more clusters, each including a key tensor and a value tensor. The number of clusters may be predetermined. For the clustering, metrics such as K-means clustering, K-nearest neighbors clustering, threshold-based clustering, a greedy algorithm, or linear programming may be used. In operation 540, the electronic device may determine a dimension size of each of plurality of clusters. The electronic device may assign different dimension sizes to the clusters. The electronic device may assign a larger dimension size to a cluster as the importance of the cluster is high, under the condition or constraint that the sum of the dimension sizes assigned to each cluster does not exceed a predefined total dimension size available. For example, when the token importance corresponding to the first cluster is greater than the token importance corresponding to the second cluster, the electronic device may assign a greater dimension size to the first cluster than to the second cluster. The dimension size assigned to each cluster may be a value within a preset range. In an embodiment, when there are a plurality of clusters, the electronic device may determine that the first cluster with the highest importance is to be fully retained (corresponding to a pruning ratio of 0%) by assigning a dimension size of 100%, and determine dimension sizes (or pruning ratios) for the remaining clusters based on a target magnitude of the given key-value cache data. The electronic device may determine the dimension sizes of the remaining clusters such that the magnitude of the key-value cache data is less than or equal to the target magnitude of the key-value cache data. As the pruning ratio increases, the dimension size of the cluster decreases, and as the pruning ratio decreases, the dimension size of the cluster may increase.

In operation 550, the electronic device may determine the channel importance of each of the channels included in at least one of the key tensor and the value tensor in each cluster. As described above, the electronic device may determine, as the channel importance, for example, a value obtained by measuring a magnitude of an interaction between the query tensor and the key tensor for each channel. The size of the matrix multiplication between the query tensor and the key tensor may be determined as the channel importance. Alternatively, the electronic device may determine the channel importance using a magnitude-based metric or a singular value-based metric.

In operation 560, the electronic device may perform channel pruning based on the determined channel importance and the dimension size of each cluster. The electronic device may prune channels which are less important (with low channel importance) among the channels of the key tensor and value tensor included in each cluster based on the channel importance and the dimension size of each cluster. When performing channel pruning, the electronic device may retain a portion of a channel dimension of at least one of the channels included in the key tensor and the value tensor, and zero-pad the remaining portion. The electronic device may replace a value of a channel to be removed according to a pruning ratio, with 0.

In operation 570, the electronic device may store the compressed key-value data as key-value cache data for a transformer-based neural network model. Through the process of performing the channel pruning according to the dimension size assigned to the cluster and the channel importance of each channel, the key-value cache data may be optimized and the optimized key-value cache data may be stored in a memory (e.g., a cache memory). In an embodiment, the electronic device may use a calibration value (or a bias value) to reduce or minimize the loss due to the channel pruning. Referring to FIG. 6, after performing the channel pruning in operation 560 of FIG. 5, in operation 610, the electronic device may determine a calibration value to calibrate for the result of the channel pruning. The electronic device may determine, as the calibration value, a value for minimizing a difference between a dot product value of the query tensor and the key tensor and a dot product value of the pruned query tensor and key tensor. The calibration value may have different values for the layer, head, key tensor, and/or value tensor of the transformer.

It is assumed that Qᵢ and Kⱼ are respectively a query tensor and a key tensor when all tokens use the entire dimension (when no channel pruning is performed), and Q̅ₜ and K̅ⱼ are respectively a query tensor and a key tensor when the entire dimension may not be used due to the channel pruning performed. The results of the dot product calculation QK^{T} used to compute the attention map may differ when channel pruning is not performed and when channel pruning is performed. At this time, when the overall result of the dot product calculation often varies in the direction of overall increase or decrease, the degradation of the performance of the transformer-based neural network model due to the channel pruning may be reduced by applying the calibration value to calibrate for the variation in the result of the dot product calculation. In operation 620, the electronic device may store the key-value data compressed through channel pruning as key-value cache data for the transformer-based neural network model, and store the calibration value determined in operation 610. The key-value cache data and the calibration value may be stored in a memory and used during the inference process of a next token. The calibration value may be applied to an input of at least one of the head and the layer of the transformer in the inference process of a next token. For example, the calibration value may be added to the input values of the head and the layer of the transformer and may be input.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, embodiments, and equivalents to the claims are also within the scope of the following claims.

What is claimed is:

1. A cache data compression method for a transformer-based neural network model, the cache data compression method comprising:
obtaining a query tensor, a key tensor, and a value tensor corresponding to tokens;
determining token importance for each of the tokens based on the query tensor and the key tensor;
clustering the key tensor and the value tensor into a plurality of clusters based on the determined token importance;
determining channel importance of channels included in at least one of the key tensor and the value tensor in each of the plurality of clusters;
generating compressed key-value data by pruning at least one of the channels of the key tensor and the value tensor based on the determined channel importance; and
storing the compressed key-value data as key-value cache data for the transformer-based neural network model.

2. The cache data compression method of claim 1, wherein the clustering comprises clustering the key tensor and the value tensor into a predetermined number of clusters.

3. The cache data compression method of claim 1, wherein the plurality of clusters have dimension sizes different from each other.

4. The cache data compression method of claim 1, wherein the clustering comprises:
determining respective dimension sizes of the plurality of clusters; and
clustering the key tensor and the value tensor into the plurality of clusters having the determined dimension sizes.

5. The cache data compression method of claim 1, wherein the generating of the compressed key-value data comprises retaining a portion of a channel dimension of at least one of the channels, and zero-padding the remaining portion.

6. The cache data compression method of claim 1, wherein the determining of the token importance comprises:
generating an attention map for each of the tokens based on the query tensor and the key tensor for each of the tokens; and
determining the token importance based on the attention map.

7. The cache data compression method of claim 1, wherein
the plurality of clusters comprises a first cluster and a second cluster, and
based on a first token importance corresponding to the first cluster, being greater than a second token importance corresponding to the second cluster, a greater dimension size is assigned to the first cluster than to the second cluster.

8. The cache data compression method of claim 1, wherein the determining of the channel importance comprises determining the channel importance of each key channel and each value channel of the plurality of clusters.

9. The cache data compression method of claim 1, wherein the generating of the compressed key-value data comprises pruning at least one channel among the channels of the key tensor and the value tensor based on a dimension size assigned to each of the plurality of clusters and the determined channel importance.

10. The cache data compression method of claim 1, further comprising:
determining a calibration value based on a result value of the pruning of the at least one of the channels of the key tensor and the value tensor based on the determined channel importance; and
storing the determined calibration value.

11. The cache data compression method of claim 10, wherein
the calibration value is a value for calibrating a dot product result value of the query tensor and the key tensor used to calculate an attention score in the transformer-based neural network model, and is applied to an input of at least one of a head and a layer of the transformer-based neural network model.

12. A non-transitory computer-readable storage medium storing instructions that, when executed by a processor of an electronic device, cause the electronic device to perform:
obtaining a query tensor, a key tensor, and a value tensor corresponding to tokens;
determining token importance for each of the tokens based on the query tensor and the key tensor;
clustering the key tensor and the value tensor into a plurality of clusters based on the determined token importance;
determining channel importance of channels included in at least one of the key tensor and the value tensor in each of the plurality of clusters;
generating compressed key-value data by pruning at least one of the channels of the key tensor and the value tensor based on the determined channel importance; and
storing the compressed key-value data as key-value cache data for a transformer-based neural network model.

13. An electronic device for performing a cache data compression method for a transformer-based neural network model, the electronic device comprising:
a memory storing instructions; and
a processor configured to execute the instructions,
wherein, when the instructions are executed by the processor, the electronic device is configured to:
obtain a query tensor, a key tensor, and a value tensor corresponding to tokens;
determine token importance for each of the tokens based on the query tensor and the key tensor;
cluster the key tensor and the value tensor for the tokens into a plurality of clusters based on the determined token importance;
determine channel importance of channels included in at least one of the key tensor and the value tensor in each of the plurality of clusters;
generate compressed key-value data by pruning at least one of the channels of the key tensor and the value tensor based on the determined channel importance; and
store the compressed key-value data in the memory as key-value cache data for the transformer-based neural network model.

14. The electronic device of claim 13, wherein, when the instructions are executed by the processor, the electronic device is configured to cluster the key tensor and the value tensor into a predetermined number of clusters.

15. The electronic device of claim 13, wherein, when the instructions are executed by the processor, the electronic device is configured to:
determine respective dimension sizes of the plurality of clusters; and
cluster the key tensor and the value tensor into the plurality of clusters having the determined dimension sizes.

16. The electronic device of claim 13, wherein, when the instructions are executed by the processor, the electronic device is configured to, when performing the pruning, retain a portion of a channel dimension of at least one of the channels included in the key tensor and the value tensor, and zero-padding the remaining portion according to the determined channel importance.

17. The electronic device of claim 13, wherein, when the instructions are executed by the processor, the electronic device is configured to:
generate an attention map for each of the tokens based on the query tensor and the key tensor for each of the tokens; and
determine the token importance based on the attention map.

18. The electronic device of claim 13, wherein, when the instructions are executed by the processor, the electronic device is configured to prune at least one channel among the channels of the key tensor and the value tensor included in at least one cluster based on a dimension size assigned to each of the plurality of clusters and the determined channel importance.

19. The electronic device of claim 13, wherein, when the instructions are executed by the processor, the electronic device is configured to:
determine a calibration value based on a result value of the pruning of the at least one of the channels of the key tensor and the value tensor based on the determined channel importance; and
store the calibration value in the memory.

20. The electronic device of claim 19, wherein
the calibration value is a value for calibrating a dot product result value of the query tensor and the key tensor used to calculate an attention score in the transformer-based neural network model, and is applied to an input of at least one of a head and a layer of the transformer-based neural network model.
